(19) United States
(12) Patent Application Publication
(10) Pub. No.: US 2024/0004898 A1
(43) Pub. Date: Jan. 4, 2024

(54) UPDATING A STAGED DATASET FOR INGESTION

(71) Applicant: Microsoft Technology Licensing, LLC, Redmond, WA (US)

(72) Inventors: Vineet BINDAL, San Jose, CA (US); Manohar SREENIVASACHAR, Sunnyvale, CA (US); Michael Allan JOHNSTON, Santa Clara, CA (US); Lengning LIU, Redmond, WA (US)

(21) Appl. No.: 18/057,516

(22) Filed: Nov. 21, 2022

Related U.S. Application Data
(60) Provisional application No. 63/357,774, filed on Jul. 1, 2022.

(51) Int. Cl. G06F 16/27; G06F 16/21; G06F 16/25; G06F 11/14

(52) U.S. Cl. CPC G06F 16/27; G06F 16/219; G06F 16/258; G06F 11/1451

(57) ABSTRACT

Updating a staged dataset from a delta-based data repository is provided, including receiving an instruction to update the staged dataset based on a checkpoint and requesting a versioned subset of data from the repository based on the checkpoint and the received instruction. The versioned subset of the data includes a data differential between a staged version of the data stored in the repository and a checkpoint-based version of the data stored in the repository. The versioned subset of the data is received from the repository. The versioned subset of the data is incompatibly formatted for ingestion by a data analytics engine. The received versioned subset of the data is transformed into a staged subset of the data. The staged subset of the data is formatted for ingestion by a data analytics engine and stored in association with another staged subset of the data for ingestion by the data analytics engine.

The present application claims benefit of priority to U.S. Provisional Patent No. 63/357,774, entitled “Updating a Staged Dataset for Ingestion” and filed on Jul. 1, 2022, which is specifically incorporated herein by reference for all that it discloses and teaches.

### BACKGROUND

Many data analytics engines ingest input data to generate output data, such as generating insights, predicting events and conditions, identifying trends, answering queries, etc. Typically, such a data analytics engine ingests large amounts of source data, which can be a resource and time-intensive operation. Accordingly, when the source data changes, the data analytics engine re-ingests the entire set of updated source data in order to provide updated output data, which is a costly endeavor.

### SUMMARY

In some aspects, the technology described herein relates to updating a staged dataset from a delta-based data repository. For example, an updating method includes: receiving an instruction to update the staged dataset based on a checkpoint; requesting a versioned subset of data from the delta-based data repository based on the checkpoint and the received instruction, wherein the versioned subset of the data includes a data differential between a staged version of the data stored in the delta-based data repository and a checkpoint-based version of the data stored in the delta-based data repository; receiving the versioned subset of the data from the delta-based data repository, wherein the versioned subset of the data is incompatibly formatted for ingestion by a data analytics engine; transforming the received versioned subset of the data into a staged subset of the data, wherein the staged subset of the data is formatted for ingestion by a data analytics engine; and storing the staged subset of the data in association with another staged subset of the data for ingestion by the data analytics engine.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates a system including an example ingestion staging engine configured to update a staged dataset for ingestion by a data analytics engine.

FIG. 2 illustrates an example data flow for ingestion staging using a stored checkpoint.

FIG. 3 illustrates an example system for updating a staged dataset for ingestion.

FIG. 4 illustrates example communications for updating a staged dataset for ingestion.

FIG. 5 illustrates example operations for updating a staged dataset for ingestion.

FIG. 6 illustrates an example computing device for use in updating a staged dataset for ingestion.

### DETAILED DESCRIPTIONS

The described technology updates input data for a data analytics engine. Source data is stored in a delta-based data repository, such as delta lake storage. “Delta lake” refers to an open format storage layer that delivers reliability, security, and performance on data lake storage to support data analytics operations and other computing purposes. Data lake storage holds a vast amount of raw data in its native format, including structured, semi-structured, and unstructured data, and provides a scalable and secure platform that allows enterprises to ingest input data from other systems, even input data from on-premise storage, off-premise storage, and/or edge-computing systems.

However, the content of a data lake repository changes over time. In this light, delta lake storage acts as an additional layer over the data lake from which “lakehouse” architecture (e.g., a combination of a data lake and a data warehouse) can be developed. Such an architecture enables a compute engine (e.g., a data analytics engine) to perform ACID (Atomicity, Consistency, Isolation, and Durability) transactions on top of data lake storage solutions.

As such, for certain activities such as Extract, Transform, Load (ETL) operations, delta lake storage provides access to original raw data and to incremental differentials (“delta”) between the original raw data and one or more changes in that raw data. Example deltas are typically recorded in a transaction log associated with the delta lake storage and may include records for different transactions on the data, including without limitation reads, deletes, updates, adds, etc. In at least one implementation, the transaction log records an ordered (e.g., ordered with time) of the transactions committed on the delta lake storage.

For example, delta lake storage may store records on 1 million products in a catalog recorded in delta lake storage. When another product is added to the catalog, an “add delta” is inserted into the transaction log of the delta lake storage to represent the newly added product. Accordingly, data for the updated catalog can be generated from the original raw data and the delta, which represents the changes from the raw data.

A delta lake transaction log can also contain statistics on the stored data. For example, depending on the type of the data/field/column, each column can have min/max values stored in association with the stored data. Such statistical metadata improves the performance of queries on the stored data.

The described technology stages data extracted from a delta-based data repository for ingestion by a data analytics engine. However, the original raw data and the one or more deltas extracted from the delta-based data repository are not formatted and/or otherwise configured for ingestion by a given data analytics engine. Accordingly, the staging includes reformatting and/or reconfiguring the original raw data and the one or more deltas into staged data sets that are compatible with the input requirements of the data analytics engine.

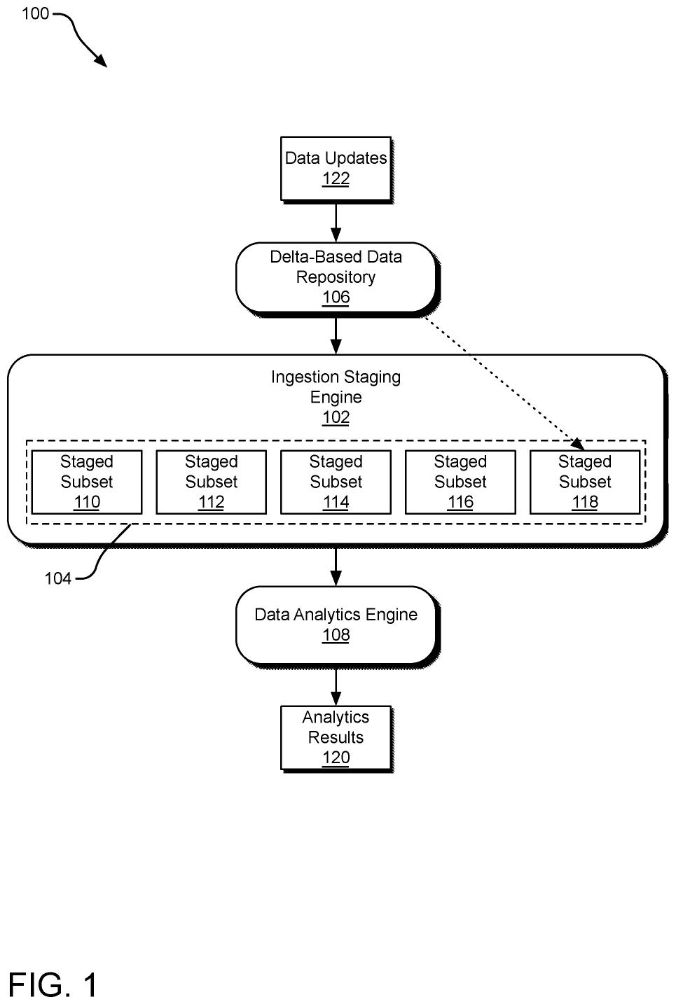

FIG. 1 illustrates a system 100 including an example ingestion staging engine 102 configured to update a staged dataset 104 for ingestion by a data analytics engine 108. The staged dataset 104 includes data that has been extracted from a delta-based data repository 106 and transformed into a structure and a format that are compatible with ingestion by the data analytics engine 108. Example data stored in the delta-based data repository 106 may include without limitation sensor data, customer data, product data, demographic data, etc. In the illustrated example, the data analytics engine 108 can access the staged dataset 104, whether as a full ingestion or an incremental ingestion, and can generate analytics results 120 therefrom. For example, the analytics results 120 may represent insights generated from the data stored in the delta-based data repository 106.

The ingestion staging engine 102 receives data from the delta-based data repository 106 and generates or supplements the staged dataset 104 based on the received data. In FIG. 1, the ingestion staging engine 102 has previously generated staged subsets of the staged dataset 104. For example, an initial staged subset 110 may represent an initial version of data received from the delta-based data repository 106 (e.g., data before any updates). As such, the ingestion staging engine 102 generated the initial staged subset 110 and added it to the staged dataset 104. Over time, data updates 122 (e.g., new sensor data, corrections to product data) were applied to the data in the delta-based data repository 106. The data updates 122 are recorded in a transaction log of the delta-based data repository 106 to track these changes.

Thereafter, the ingestion staging engine 102 receives three delta updates from the delta-based data repository 106, which the ingestion staging engine 102 transforms into staged subsets 112, 114, and 116 and adds them to the staged dataset 104. For example, the staged subsets 112, 114, and 116 may represent daily deltas or deltas for some other periodic or specified points in time. This approach alleviates a need to regenerate a complete representation of a data version with each update—instead, staged subsets can be generated for each data version using deltas from the previous data versions, and the data analytics engine 108 can fully ingest all of the staged subsets (full ingestion) or incrementally ingest the new staged subsets (incremental ingestion) to generate updated analytics results 120.

A staged subset 118 represents a subset of data corresponding to a newer data update in the delta-based data repository 106. As with the staged subsets 112, 114, and 116, the staged subset 118 incorporates data updates received from the delta-based data repository 106, which have been transformed for compatibility with ingestion by the ingestion staging engine 102. Rather than creating a completely new staged data set, the ingestion staging engine 102 creates yet another staged subset (the staged subset 118, as indicated by the dashed arrow) to represent the newest updates. Accordingly, in one implementation, an updated version of the data may be ingested by the data analytics engine 108 from the staged dataset 104 for any point in time using one or more of the staged subsets in the staged dataset 104.

In one implementation, the delta-based data repository 106 may be in the form of a “delta lake,” but other forms of delta-based storage may be employed. The delta-based data repository 106 stores data, and deltas are recorded in association with that data over time. Accordingly, the data and the deltas may be retrieved to build a specified version of the data, such as a version of the data corresponding to a particular date and time (collectively, “time”) specified by a checkpoint.

In various implementations, the data analytics engine 108 can ingest (e.g., input for processing) the staged subsets of the staged dataset 104 in a full ingestion or in incremental ingestions. During full ingestion, the data analytics engine 108 inputs the staged dataset 104 from the initial staged subset 110 and potentially one or more subsequent staged datasets (e.g., staged subset 112 et seq.) and processes this newly ingested data. In contrast, during incremental ingestion, the data analytics engine 108 has previously ingested some portion of the staged dataset and then incrementally ingests one or more new staged datasets to update its analytics results 120. In this scenario, for example, the ingestion staging engine 102 uses a checkpoint that specifies the time of the most recent update from the delta-based data repository 106 and requests a new update from that checkpoint to the current time. The ingestion staging engine 102 then transforms the new update into a new staged subset and adds it to the staged dataset 104 to update the staged dataset 104. The checkpoint can be obtained from local or remote storage by the ingestion staging engine 102, received from data analytics engine 108 as part of an update request, or via other means.

Furthermore, in some implementations, a user may discover that the analytics results 120 are corrupt, such as by corruption of one or more of the staged subsets in the staged dataset 104. In this scenario, for example, the ingestion staging engine 102 uses a checkpoint that specifies an arbitrary time to which an update is to “roll back” the staged subsets in the staged dataset 104. The ingestion staging engine 102 requests a new delta from the delta-based data repository 106 going back to the specified checkpoint and requests a new update from that checkpoint to the current time. The ingestion staging engine 102 then transforms the new update into a new staged subset and replaces the corresponding (covering the checkpoint to the current time) staged subsets with the new update data in the staged dataset 104. The checkpoint can be accessed from local or remote storage by the ingestion staging engine 102, received from data analytics engine 108 as part of an update request, or via other means. Regardless of whether an update or a roll back is applied, the staged dataset 104 is modified to include the updated data. Thereafter, the data analytics engine 108 can ingest some or all of the staged dataset 104 to provide updated analytics results.

It should be understood that, in some implementations, rather than updating the time period between the checkpoint and the current time, the update request can also specify a second checkpoint that specifies a different end time than the current time. In this manner, time slices of the delta-based data repository may be extracted, transformed, and added to the staged dataset 104.

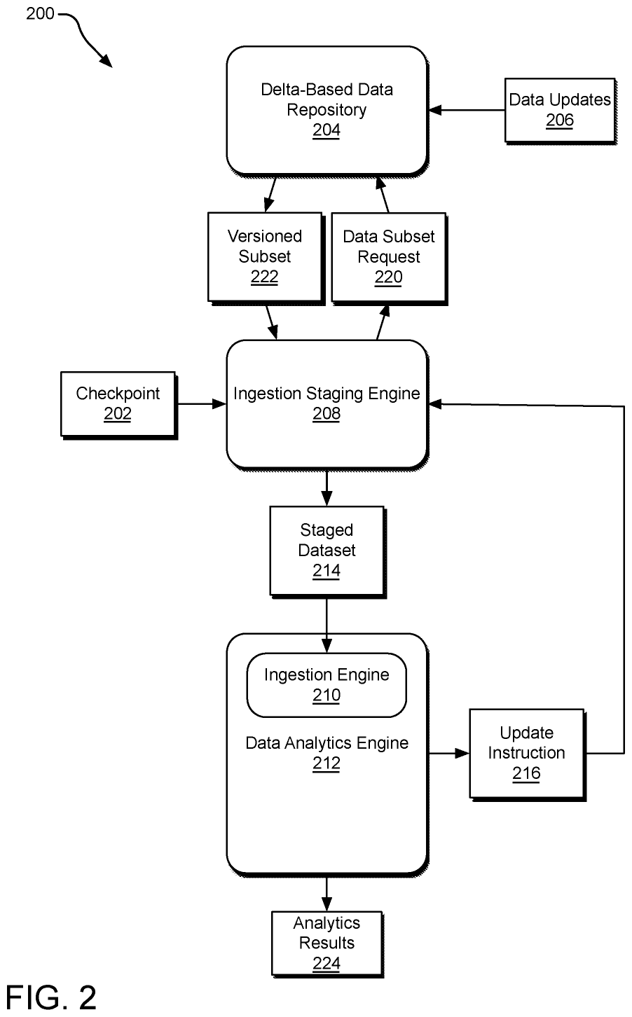

FIG. 2 illustrates an example data flow 200 for ingestion staging using a checkpoint 202. A delta-based data repository 204 stores data that can change over time. Such data changes (e.g., data updates 206) are recorded as deltas in the delta-based data repository, e.g., as recorded in a transaction log or some other delta storage construct. An ingestion staging engine 208 requests a version of the data from the delta-based data repository 204, such as a delta based on a checkpoint, transforms that data for ingestion by an ingestion engine 210 of a data analytics engine 212. The transformed data is provided to the ingestion engine 210 as a staged dataset 214, which may include multiple staged subsets corresponding to different deltas of the data.

The data and deltas in the delta-based data repository 204 are generally not compatible (e.g., based on format, database design, and/or other ingestion requirements of the ingestion engine 210 or the data analytics engine 212) for ingestion by the data analytics engine 212. Accordingly, the ingestion staging engine 208 reformats and/or otherwise transforms (e.g., merges columns) the data received from the delta-based data repository 204 to be compatible with ingestion by the data analytics engine 212.

The data analytics engine 212 requests updated data from the delta-based data repository 204 by sending an update instruction 216 to the ingestion staging engine 208. In FIG. 2, the ingestion staging engine 208 accesses a checkpoint 202 indicating the time of the most recent update. The checkpoint 202 may be stored in a storage system locally or remotely accessible by the ingestion staging engine 208, which generates a data subset request 220 and sends it to the delta-based data repository 204. For example, the data subset request 220 may request a version of the data from the delta-based data repository 204 corresponding to the time period between the checkpoint 202 and the current time. In response to the data subset request 220, the delta-based data repository 204 returns a versioned subset 222 of the data corresponding to the requested time period between the checkpoint 202 and the current time.

The ingestion staging engine 208 transforms the versioned subset 222 into a staged subset and adds it to the staged dataset 214. The ingestion engine 210 inputs the staged dataset 214, which is compatible with ingestion by the data analytics engine 212, to update its analytics results 224 with the most updated input data (i.e., the updated staged dataset 214).

In an alternative implementation, the checkpoint 202 may be provided in or in association with the update instruction 216. This alternative implementation is particularly useful in roll back scenarios, although it may also be used in update scenarios. For example, rather than having the ingestion staging engine 208 input a stored value of a checkpoint 202 representing the most recent update, the checkpoint 202 may be communicated with the update instruction 216 to specify a different checkpoint, such as a time before the most recent update. In this manner, the staged dataset 214 can be rolled back to an earlier date, overwriting potentially corrupt staged subsets in the staged dataset 214. Accordingly, such a roll back can potentially cleanse the input data for the data analytics engine 212 and generate cleansed analytics results. It should also be understood that the update instruction 216 may also include or be associated with a second checkpoint that specifies a different end time than the current time, as discussed with respect to FIG. 1.

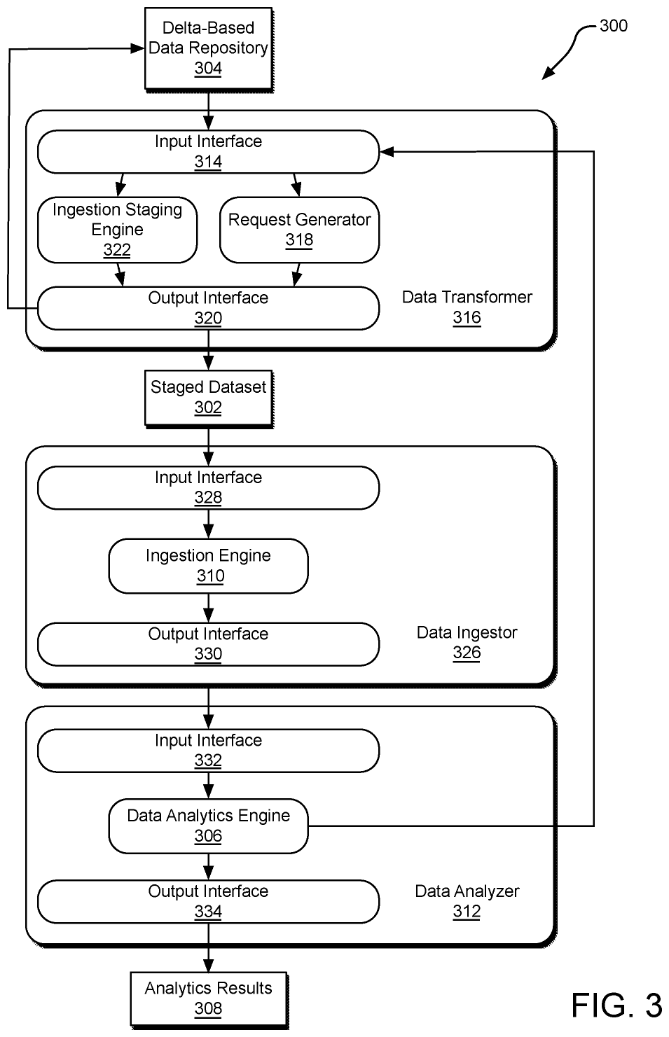

FIG. 3 illustrates an example system 300 for updating a staged dataset 302 for ingestion. A delta-based data repository 304 includes data on which a data analytics engine 306 can operate to generate analytics results 308. Content of the delta-based data repository 304 tends to change over time (e.g., with new sensor data, corrections to product data). As such, the delta-based data repository 304 includes a transaction log to track these changes as deltas, thereby allowing a generation of a dataset corresponding to different points in time. Example data stored in the delta-based data repository 304 may include without limitation sensor data, customer data, product data, demographic data, etc. In the illustrated example, the data analytics engine 306 can access the staged dataset 302 via an ingestion engine 310, whether as a full ingestion or an incremental ingestion, and can generate analytics results 308 therefrom. For example, the analytics results 308 may represent insights generated from the data stored in the delta-based data repository 304.

In one implementation, the delta-based data repository 304 may be in the form of a “delta lake,” but other forms of delta-based storage may be employed. The delta-based data repository 304 stores data, and the deltas are stored in association with that data over time (e.g., in a transaction log). Accordingly, the data and the deltas may be retrieved to build a specified version of the data, such as a version of the data corresponding to a particular date and time (collectively, “time”) specified by a checkpoint.

In an initial stage, the data analytics engine 306 in a data analyzer 312 requests an initial load of data from the delta-based data repository 304 via an input interface 314 of a data transformer 316. The request from the data analytics engine 306 triggers a request generator 318 of the data transformer 316 to generate a request based on a checkpoint, which may be provided with the request from the data analytics engine 306 or accessed from other storage. The data analytics engine 306 sends the request generated by the request generator 318 to the delta-based data repository 304 via an output interface 320.

The delta-based data repository 304 generates a dataset based at least in part upon the request from the request generator 318. For example, the checkpoint in this initial stage may specify the earliest time (e.g., the start of the data on the requested subject matter) in order to collect and ingest all of the data available in the delta-based data repository 304 on the requested subject matter up to the current time. In other implementations, a second checkpoint may also be applied to specify a time slice version of the data (e.g., from the start of the data to some point in time that is earlier than the current time).

The delta-based data repository 304 inputs the generated dataset to the data transformer 316 via the input interface 314. An ingestion staging engine 322 transforms the received dataset to be compatible with the ingestion engine 310 and the data analytics engine 306 to generate a staged dataset 302, which is output from the data transformer 316 via the output interface 320. The term “staged” indicates that the dataset (or a subset) has been transformed to be compatible for ingestion.

A data ingestor 326 receives the staged dataset 302 via an input interface 328 and through to the ingestion engine 310, which in the initial stage typically ingests the full staged dataset 302, although it may alternatively perform an incremental ingestion. The data ingestor 326 outputs the ingested data via an output interface 330 to the data analyzer 312, which inputs the ingested data via an input interface 332. The data analytics engine 306 performs its analysis of the ingested data and generates the analytics results (e.g., insights), which it outputs via an output interface 334.

In a subsequent stage involving data updates to the delta-based data repository 304, the data analytics engine 306 requests an update from the data transformer 316 based on a checkpoint. In one implementation of this subsequent stage, the checkpoint specifies the time of the most recent (previous) ingestion, and the request indicates an update from the most recent ingestion to the current time. In this manner, the data analytics engine 306 updates the staged dataset 302 with all new data in the delta-based data repository 304 on the requested subject matter (e.g., a new staged subset is added to the staged dataset 302). In other implementations, a time slice version (e.g., between two points in time) or a roll-back version (e.g., including data prior to the most recent ingestion) may be requested using one or more checkpoints and/or other parameters. In these scenarios, some or all of the staged subsets in the staged dataset 302 are replaced with the newly generated staged subsets specified by the request.

In FIG. 3, the data ingestor 326 and the data analyzer 312 are shown as separate components of the system 300. In alternative implementations, two or more of the data transformer 316, the data ingestor 326, and the data analyzer 312 can be merged into an integrated component. Accordingly, the various interfaces may be combined and/or the various interfaces may continue to manage communications between the data transformer 316, the data ingestor 326, and/or the data analyzer 312 by such interfaces (e.g., APIs, method calls, data busses).

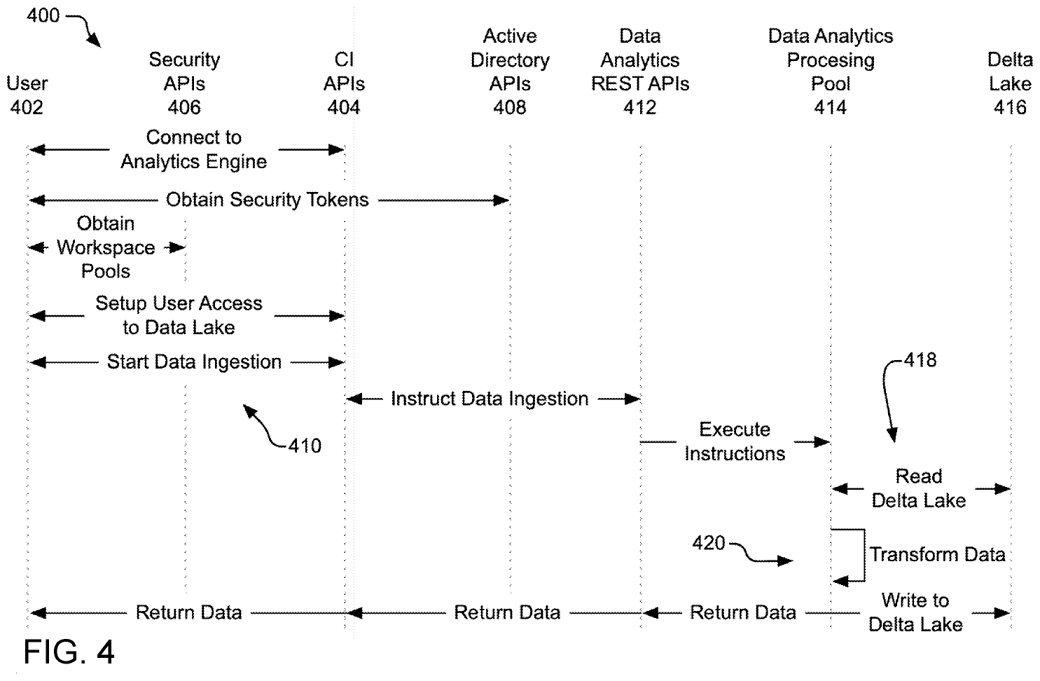

FIG. 4 illustrates example communications 400 for updating a staged dataset for ingestion. A user 402 (a “client”) initiates an update by creating a data analytics engine connection via CI (Customer Insight) application programming interfaces (APIs) 404, abbreviated as “CIAPI.” Security is enforced with an access token for Azure Resource Manager (ARM) APIs 406 via Azure Active Directory (AAD) 408. The user sets up the update request via the CI APIs 404 and triggers the generation of at least one staged subset of data from a delta-based data repository (e.g., a delta lake) 416 at communications 410.

A pool includes a set of metadata that defines the compute resource requirements and associated behavior characteristics when a data analytics instance is instantiated. These characteristics include but are not limited to name, number of nodes, node size, scaling behavior, and time to live. A pool in itself does not consume resources—there are little or no costs incurred with creating pools. Charges are incurred once a job is executed on the target pool, and the data processing instance is instantiated on demand.

In FIG. 4, the communications 410 starts the update of a full ingestion, which requests all of the data in the delta-based data repository pertaining to the requested subject matter. Alternatively, the communications 410 may request and start an update for incremental ingestion, in which the delta-based data repository provides a checkpoint-based subset of the data pertaining to the requested subject matter.

Communications between the CI APIs 404 and data analytics REST APIs 412 start a data processing session. The data analytics REST APIs refer to Representational State Transfer (REST) APIs, which are service endpoints that support sets of HTTP operations (methods) and provide create, retrieve, update, or delete access to the service's resources. A data processing session is an entry point to a data processing application that processes data in the delta-based data repository in response to the communications 410 to generate a staged subset of data, whether for full ingestions or incremental ingestion. The CI APIs 404 initiate execution of statements through the data analytics REST APIs 412 on a data analytics processing pool 414 (e.g., a workplace pool), which receives the requested data from the delta-based data repository (implemented in this example on Azure Data Lake Storage (ADSL) 416, although other storage solutions may be employed). In communications 418, the data analytics processing pool 414 reads the requested data from the delta-based data repository and transforms the requested data in operation 420 for ingestion as a staged subset.

A similar sequence of operations is employed for updating a staged dataset for a full staged ingestion and an incremental staged ingestion. During incremental ingestion, one or more staged subsets have already been ingested by the ingestion engine, and the data analytics engine has requested a data update from the ingestion staging engine, which requests an update from the delta-based data repository, transforms the update into a staged subset, and adds the staged subset into the staged dataset. It should be understood that some implementations replace one or more staged subsets already stored in the staged dataset with the new staged subset (e.g., during a roll back). Furthermore, one or more checkpoints may be employed in specifying the time period from which the associated deltas are retrieved.

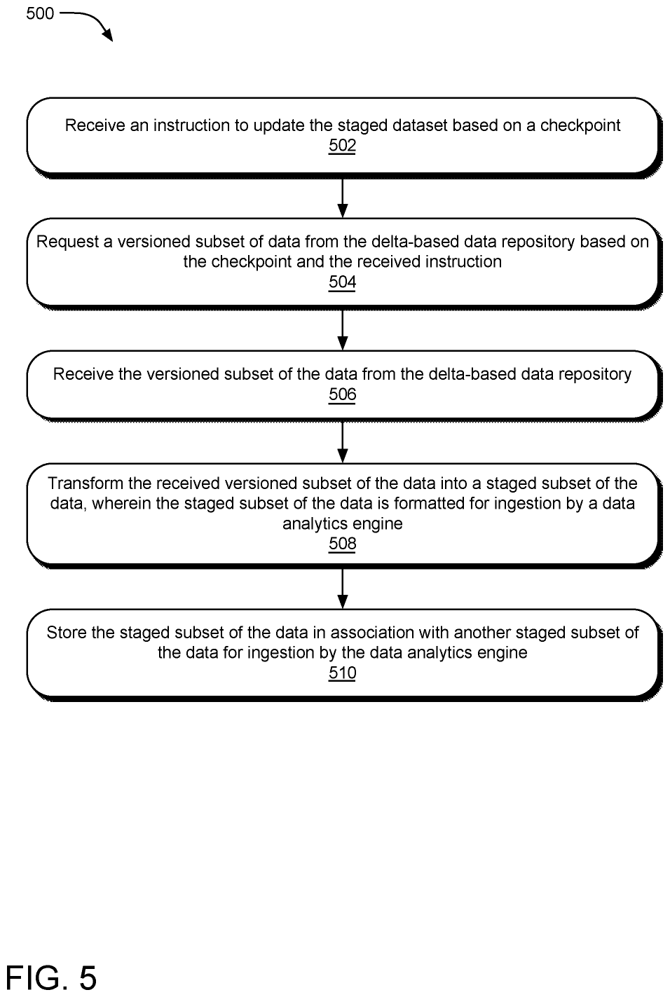

FIG. 5 illustrates example operations 500 for updating a staged dataset for ingestion. The staged dataset is updated from a delta-based data repository. A receiving operation 502 receives an instruction to update the staged dataset based on a checkpoint. A requesting operation 504 requests a versioned subset of data from the delta-based data repository based on the checkpoint and the received instruction, wherein the versioned subset of the data includes a data differential between a staged version of the data stored in the delta-based data repository and a checkpoint-based version of the data stored in the delta-based data repository. The checkpoint identifies at least one bound on the data requested from the delta-based data repository. Additional checkpoints may also be used, for example, to define one or more time slices of data to be extracted from the delta-based data repository. A receiving operation 506 receives the versioned subset of the data from the delta-based data repository, wherein the versioned subset of the data is incompatibly formatted for ingestion by a data analytics engine.

A transformation operation 508 transforms the received versioned subset of the data into a staged subset of the data, wherein the staged subset of the data is formatted for ingestion by a data analytics engine. A storing operation 510 stores the staged subset of the data in association with another staged subset of the data for ingestion by the data analytics engine. For example, during an initial stage, a full ingestion may have occurred to include one staged subset representing all of the available data pertaining to the requested subject matter. In a subsequent stage. A new staged subset can be generated (e.g., by an ingestion staging engine) and added to the staged dataset. In an alternative implementation (e.g., a roll back), the new staged subset can replace one or more of the staged subsets in the staged dataset.

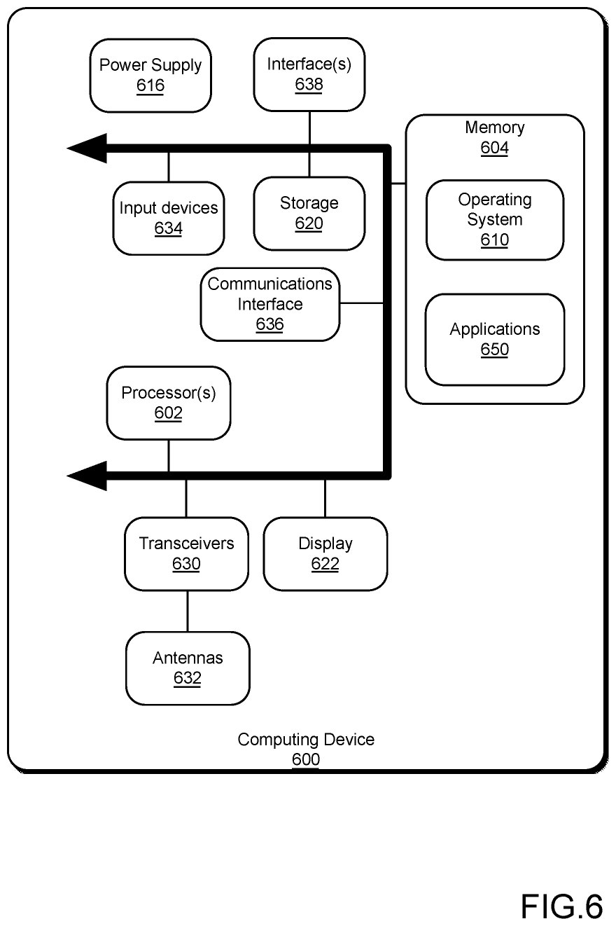

FIG. 6 illustrates an example computing device for updating a staged dataset for ingestion. The computing device 600 may be a client device, such as a laptop, mobile device, desktop, tablet, or a server/cloud device. The computing device 600 includes one or more processor(s) 602, and a memory 604. The memory 604 generally includes both volatile memory (e.g., RAM) and nonvolatile memory (e.g., flash memory). An operating system 610 resides in the memory 604 and is executed by the processor(s) 602.

In an example computing device 600, as shown in FIG. 6, one or more modules or segments, such as applications 650, an input interface, an output interface, an ingestion staging engine, an ingestion engine, a data analytics engine, a request generator, a data transformer, a data ingestor, and other modules are loaded into the operating system 610 on the memory 604 and/or storage 620 and executed by processor(s) 602. The storage 620 may store the content of a delta-based data repository, a transaction log, a request, a checkpoint, a staged dataset, a staged subset, analytics results, and other data and be local to the computing device 600 or may be remote and communicatively connected to the computing device 600. In one implementation, an input interface, an output interface, an ingestion staging engine, an ingestion engine, a data analytics engine, a request generator, a data transformer, a data ingestor, etc. may be implemented entirely in hardware or in a combination of hardware circuitry and software.

The computing device 600 includes a power supply 616, which is powered by one or more batteries or other power sources, and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers and/or client devices (e.g., mobile devices, desktop computers, or laptop computers). The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible communications signals (such as signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

Clause 1. A method of updating a staged dataset from a delta-based data repository, the method comprising: receiving an instruction to update the staged dataset based on a checkpoint; requesting a versioned subset of data from the delta-based data repository based on the checkpoint and the received instruction, wherein the versioned subset of the data includes a data differential between a staged version of the data stored in the delta-based data repository and a checkpoint-based version of the data stored in the delta-based data repository; receiving the versioned subset of the data from the delta-based data repository, wherein the versioned subset of the data is incompatibly formatted for ingestion by a data analytics engine; transforming the received versioned subset of the data into a staged subset of the data, wherein the staged subset of the data is formatted for ingestion by a data analytics engine; and storing the staged subset of the data in association with another staged subset of the data for ingestion by the data analytics engine.

Clause 2. The method of any preceding method clause, further comprising: communicating the staged subset of the data to the data analytics engine for ingestion.

Clause 3. The method of any preceding method clause, wherein the checkpoint is communicated with the received instruction.

Clause 4. The method of any preceding method clause, wherein the instruction is received by a request generator of a data transformer and the checkpoint is obtained from storage by the request generator of the data transformer.

Clause 5. The method of any preceding method clause, wherein the transforming operation reformats the data received from the delta-based data repository into a format that is compatible for ingestion by the data analytics engine.

Clause 6. The method of any preceding method clause, wherein the delta-based data repository includes a delta lake.

Clause 7. The method of any preceding method clause, wherein the delta-based data repository includes a data lake.

Clause 8. A system for updating a staged dataset from a delta-based data repository, the system comprising: one or more hardware processors; an input interface of a data transformer, the input interface being executable by the one or more hardware processors and configured to receive an instruction to update the staged dataset based on a checkpoint; a request generator of the data transformer executable by the one or more hardware processors and configured to request a versioned subset of data from the delta-based data repository based on the checkpoint and the received instruction, wherein the versioned subset of the data includes a data differential between a staged version of the data stored in the delta-based data repository and a checkpoint-based version of the data stored in the delta-based data repository, wherein the input interface is further configured to receive the versioned subset of the data from the delta-based data repository, wherein the versioned subset of the data is incompatibly formatted for ingestion by a data analytics engine; an ingestion staging engine of a data transformer executable by the one or more hardware processors and configured to transform the received versioned subset of the data into a staged subset of the data, wherein the staged subset of the data is formatted for ingestion by a data analytics engine; and an output interface of the data transformer executable by the one or more hardware processors and configured to store the staged subset of the data in association with another staged subset of the data for ingestion by the data analytics engine.

Clause 9. The system of any preceding system clause, further comprising: a data ingestor executable by the one or more hardware processors and configured to communicate the staged subset of the data to the data analytics engine for ingestion.

Clause 10. The system of any preceding system clause, wherein the checkpoint is communicated with the received instruction.

Clause 11. The system of any preceding system clause, wherein the instruction is received by the request generator of a data transformer and the checkpoint is obtained from storage by the request generator of the data transformer.

Clause 12. The system of any preceding system clause, wherein the ingestion staging engine reformats the data received from the delta-based data repository into a format that is compatible for ingestion by the data analytics engine.

Clause 13. The system of any preceding system clause, wherein the delta-based data repository includes a delta lake.

Clause 14. The system of any preceding system clause, wherein the delta-based data repository includes a data lake.

Clause 15. One or more tangible processor-readable storage media embodied with instructions for executing on one or more processors and circuits of a computing device a process for updating a staged dataset from a delta-based data repository, the process comprising: receiving an instruction to update the staged dataset based on a checkpoint; requesting a versioned subset of data from the delta-based data repository based on the checkpoint and the received instruction, wherein the versioned subset of the data includes a data differential between a staged version of the data stored in the delta-based data repository and a checkpoint-based version of the data stored in the delta-based data repository; receiving the versioned subset of the data from the delta-based data repository, wherein the versioned subset of the data is incompatibly formatted for ingestion by a data analytics engine; transforming the received versioned subset of the data into a staged subset of the data, wherein the staged subset of the data is formatted for ingestion by a data analytics engine; and storing the staged subset of the data in association with another staged subset of the data in a staged dataset for ingestion by the data analytics engine.

Clause 16. The one or more tangible processor-readable storage media of any preceding media clause, wherein the process further comprises: communicating the staged subset of the data to the data analytics engine for ingestion.

Clause 17. The one or more tangible processor-readable storage media of any preceding media clause, wherein the checkpoint is communicated with the received instruction.

Clause 18. The one or more tangible processor-readable storage media of any preceding media clause, wherein the instruction is received by a request generator of a data transformer and the checkpoint is obtained from storage by the request generator of the data transformer.

Clause 19. The one or more tangible processor-readable storage media of any preceding media clause, wherein the transforming operation reformats the data received from the delta-based data repository into a format that is compatible for ingestion by the data analytics engine.

Clause 20. The one or more tangible processor-readable storage media of any preceding media clause, wherein the delta-based data repository includes a delta lake.

Clause 21. A system for updating a staged dataset from a delta-based data repository, the system comprising: means for receiving an instruction to update the staged dataset based on a checkpoint; means for requesting a versioned subset of data from the delta-based data repository based on the checkpoint and the received instruction, wherein the versioned subset of the data includes a data differential between a staged version of the data stored in the delta-based data repository and a checkpoint-based version of the data stored in the delta-based data repository; means for receiving the versioned subset of the data from the delta-based data repository, wherein the versioned subset of the data is incompatibly formatted for ingestion by a data analytics engine; means for transforming the received versioned subset of the data into a staged subset of the data, wherein the staged subset of the data is formatted for ingestion by a data analytics engine; and means for storing the staged subset of the data in association with another staged subset of the data for ingestion by the data analytics engine.

Clause 22. The system of any preceding system clause, further comprising: means for communicating the staged subset of the data to the data analytics engine for ingestion.

Clause 23. The system of any preceding system clause, wherein the checkpoint is communicated with the received instruction.

Clause 24. The system of any preceding system clause, wherein the instruction is received by a request generator of a data transformer and the checkpoint is obtained from storage by the request generator of the data transformer.

Clause 25. The system of any preceding system clause, wherein the means for transforming reformats the data received from the delta-based data repository into a format that is compatible for ingestion by the data analytics engine.

Clause 26. The system of any preceding system clause, wherein the delta-based data repository includes a delta lake.

Clause 27. The system of any preceding system clause, wherein the delta-based data repository includes a data lake.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of updating a staged dataset from a delta-based data repository, the method comprising:
receiving an instruction to update the staged dataset based on a checkpoint;
requesting a versioned subset of data from the delta-based data repository based on the checkpoint and the received instruction, wherein the versioned subset of the data includes a data differential between a staged version of the data stored in the delta-based data repository and a checkpoint-based version of the data stored in the delta-based data repository;
receiving the versioned subset of the data from the delta-based data repository, wherein the versioned subset of the data is incompatibly formatted for ingestion by a data analytics engine;
transforming the received versioned subset of the data into a staged subset of the data, wherein the staged subset of the data is formatted for ingestion by a data analytics engine; and
storing the staged subset of the data in association with another staged subset of the data for ingestion by the data analytics engine.

2. The method of claim 1, further comprising:
communicating the staged subset of the data to the data analytics engine for ingestion.

3. The method of claim 1, wherein the checkpoint is communicated with the received instruction.

4. The method of claim 1, wherein the instruction is received by a request generator of a data transformer and the checkpoint is obtained from storage by the request generator of the data transformer.

5. The method of claim 1, wherein the transforming operation reformats the data received from the delta-based data repository into a format that is compatible for ingestion by the data analytics engine.

6. The method of claim 1, wherein the delta-based data repository includes a delta lake.

7. The method of claim 1, wherein the delta-based data repository includes a data lake.

8. A system for updating a staged dataset from a delta-based data repository, the system comprising:
one or more hardware processors;
an input interface of a data transformer, the input interface being executable by the one or more hardware processors and configured to receive an instruction to update the staged dataset based on a checkpoint;
a request generator of the data transformer executable by the one or more hardware processors and configured to request a versioned subset of data from the delta-based data repository based on the checkpoint and the received instruction, wherein the versioned subset of the data includes a data differential between a staged version of the data stored in the delta-based data repository and a checkpoint-based version of the data stored in the delta-based data repository, wherein the input interface is further configured to receive the versioned subset of the data from the delta-based data repository, wherein the versioned subset of the data is incompatibly formatted for ingestion by a data analytics engine;
an ingestion staging engine of a data transformer executable by the one or more hardware processors and configured to transform the received versioned subset of the data into a staged subset of the data, wherein the staged subset of the data is formatted for ingestion by a data analytics engine; and
an output interface of the data transformer executable by the one or more hardware processors and configured to store the staged subset of the data in association with another staged subset of the data for ingestion by the data analytics engine.

9. The system of claim 8, further comprising:
a data ingestor executable by the one or more hardware processors and configured to communicate the staged subset of the data to the data analytics engine for ingestion.

10. The system of claim 8, wherein the checkpoint is communicated with the received instruction.

11. The system of claim 8, wherein the instruction is received by the request generator of a data transformer and the checkpoint is obtained from storage by the request generator of the data transformer.

12. The system of claim 8, wherein the ingestion staging engine reformats the data received from the delta-based data repository into a format that is compatible for ingestion by the data analytics engine.

13. The system of claim 8, wherein the delta-based data repository includes a delta lake.

14. The system of claim 8, wherein the delta-based data repository includes a data lake.

15. One or more tangible processor-readable storage media embodied with instructions for executing on one or more processors and circuits of a computing device a process for updating a staged dataset from a delta-based data repository, the process comprising:
receiving an instruction to update the staged dataset based on a checkpoint;
requesting a versioned subset of data from the delta-based data repository based on the checkpoint and the received instruction, wherein the versioned subset of the data includes a data differential between a staged version of the data stored in the delta-based data repository and a checkpoint-based version of the data stored in the delta-based data repository;
receiving the versioned subset of the data from the delta-based data repository, wherein the versioned subset of the data is incompatibly formatted for ingestion by a data analytics engine;
transforming the received versioned subset of the data into a staged subset of the data, wherein the staged subset of the data is formatted for ingestion by a data analytics engine; and
storing the staged subset of the data in association with another staged subset of the data in a staged dataset for ingestion by the data analytics engine.

16. The one or more tangible processor-readable storage media of claim 15, wherein the process further comprises:
communicating the staged subset of the data to the data analytics engine for ingestion.

17. The one or more tangible processor-readable storage media of claim 15, wherein the checkpoint is communicated with the received instruction.

18. The one or more tangible processor-readable storage media of claim 15, wherein the instruction is received by a request generator of a data transformer and the checkpoint is obtained from storage by the request generator of the data transformer.

19. The one or more tangible processor-readable storage media of claim 15, wherein the transforming operation reformats the data received from the delta-based data repository into a format that is compatible for ingestion by the data analytics engine.

20. The one or more tangible processor-readable storage media of claim 15, wherein the delta-based data repository includes a delta lake.
